(19) United States
(12) Patent Application Publication
(10) Pub. No.: US 2016/0109702 A1
(43) Pub. Date: Apr. 21, 2016

(54) DUST COVER ASSEMBLY AND HEAD-UP DISPLAY DEVICE INCLUDING THE SAME

(71) Applicant: HYUNDAI MOBIS CO., LTD., Seoul (KR)

(72) Inventor: Ki Hyuk SONG, Yongin-si (KR)

(21) Appl. No.: 14/732,456

(22) Filed: Jun. 5, 2015

(30) Foreign Application Priority Data
Oct. 15, 2014 (KR) 10-2014-0139304

(51) Int. Cl. G02B 27/01; G02B 27/00; G02B 1/08; G02B 1/10

(52) U.S. Cl. CPC G02B 27/0101; G02B 1/10; G02B 27/0006; G02B 1/08; G02B 2027/0118

(57) ABSTRACT

A head-up display device includes: a dust cover assembly; a picture generating unit configured to generate an optical signal corresponding to an image; a mirror unit configured to receive the optical signal from the picture generating unit and reflect the optical signal to the dust cover assembly; and a windshield configured to convert the optical signal having a polarization direction adjusted by the dust cover assembly into a virtual image.

### CROSS-REFERENCE TO RELATED APPLICATIONS

This application claims priority to and the benefit of Korean Patent Application No. 10-2014-0139304 filed in the Korean Intellectual Property Office on Oct. 15, 2014, the entire contents of which are incorporated herein by reference.

### TECHNICAL FIELD

The present disclosure relates to a dust cover assembly and a head-up display device including the same.

### BACKGROUND ART

A head-up display device (HUD) is a device for visualizing traveling information and like of a vehicle as a virtual image and displaying the virtual image in front of a driver's view, and assists in safe driving by enhancing a concentration level of a driver when eyes keep looking forward.

### SUMMARY

Aspects of the present invention provide a dust cover assembly and a head-up display device including the same capable of enhancing brightness of a virtual image, which is converted from an optical signal and displayed, by correcting a polarization direction of an optical signal rotated by a mirror or a reflective coating of the mirror by applying a phase delay film having an anisotropic crystal structure to a dust cover.

An embodiment of the present invention provides a dust cover assembly including; a dust cover configured to transmit an optical signal; and a phase delay film overlapping the dust cover and configured to adjust a polarization direction by delaying a phase of the optical signal incident from the dust cover so as to transmit the optical signal having the adjusted polarization direction.

The polarization direction of the optical signal may be adjusted by an anisotropic crystal structure having a phase delay value of the phase delay film.

The phase delay value may be determined by tensioning, coating, and polymerizing the phase delay film.

The phase delay value may be set based on a center wavelength in a visible light region of the optical signal.

The phase delay film may be made of polycarbonate (PC) or polymethyl methacrylate (PMMA).

A polarization direction of the optical signal may be adjusted to be polarized at 180°.

The dust cover may be made of PC which blocks foreign substances such as dust and transmits the optical signal.

Another embodiment of the present invention provides a head-up display device including: a dust cover assembly; a picture generating unit configured to generate an optical signal corresponding to an image; a mirror unit configured to receive the optical signal from the picture generating unit and reflect the optical signal to the dust cover assembly; and a windshield configured to convert the optical signal having a polarization direction adjusted by the dust cover assembly into a virtual image.

The picture generating unit may be an LCD type or a DLP scanning type.

According to embodiments of the present invention, it is possible to enhance brightness of a virtual image, which is converted from an optical signal and displayed, by correcting a polarization direction of an optical signal rotated by a mirror or a reflective coating of the mirror by applying a phase delay film having an anisotropic crystal structure to a dust cover.

The brightness of the virtual image is enhanced, such that visibility for a driver may be improved and the number of light emitting elements may be reduced, thereby decreasing power consumption.

It is not required to use a separate phase delay film in other components, such that the number of components is reduced, thereby saving cost.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram for describing a polarization angle according to the related art.

FIG. 2 is a block diagram schematically illustrating a head-up display device according to an embodiment of the present invention.

FIGS. 3A and 3B are diagrams for describing a comparison between a head-up display device according to the related art and the head-up display device including a dust cover assembly according to an embodiment of the present invention.

FIG. 4 is a diagram for describing a phase delay film of a dust cover assembly according to an embodiment of the present invention.

FIG. 5 is a diagram for describing a polarization direction of an optical signal rotating around an optical axis by a phase delay film of the dust cover assembly according to an embodiment of the present invention.

FIG. 6 is a diagram for describing that a form of an optical signal is changed from circular polarization to linear polarization by a phase delay film of a dust cover assembly according to an embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts throughout the several figures of the drawing.

### DETAILED DESCRIPTION

To sufficiently understand the present invention the accompanying drawings illustrating embodiments of the present invention and contents described therein need to referred to.

Hereinafter, the present invention will be described in detail by describing embodiments of the present invention with reference to the accompanying drawings. However, the present invention may be implemented in various different forms, and is not limited to the embodiments described herein. A part irrelevant to the description will be omitted to clearly describe embodiments of the present invention, and the same or similar members will be designated by the same reference numerals in the drawings.

Throughout the specification, unless explicitly described to the contrary, the word “comprise” and variations such as “comprises” or “comprising”, will be understood to imply the inclusion of stated elements but not the exclusion of any other elements. Further, the terms “-er”, “-or”, “module”, and “block” described in the specification mean units for processing at least one function or operation and can be implemented by hardware components or software components or combinations thereof.

In a head-up display device, a liquid crystal display (LCD) is used for a picture generating unit (PGU), and the LCD adopts an absorptive polaroid film for an incident surface and a light emitting surface in order to optically control an optical signal that is outputted from the picture generating unit and converted into an image.

The absorptive polaroid film used for the LCD has a property of selectively passing or blocking vertical polarization (P polarization) or horizontal polarization (S polarization) of an optical signal, such that an optical signal incident onto the LCD from the picture generating unit of the head-up display device is finally transmitted in a predetermined form, specifically, linear polarization by the polaroid film of the LCD.

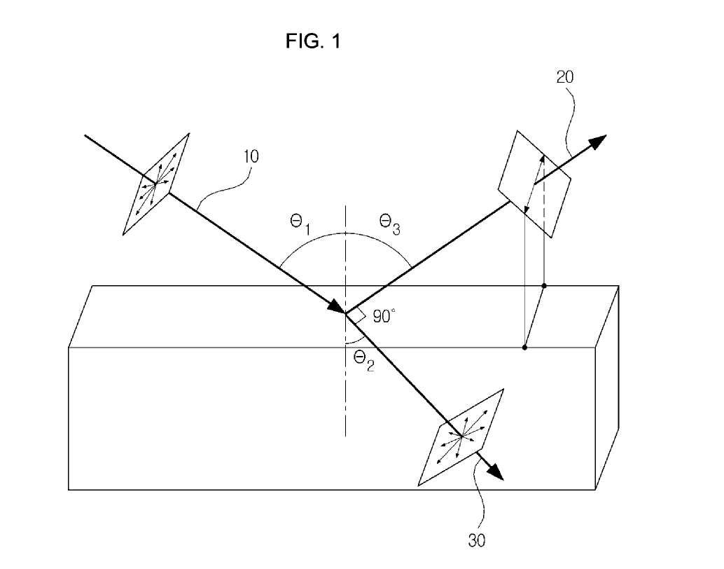

Referring to FIG. 1, an optical signal 10 has properties of both a particle and a wave and has reflection efficiency which is varied depending on an incidence angle θ₁ due to the property of a wave. For example, when unpolarized light is incident onto a medium having a certain difference in refractive index, a property of polarization reflected is changed according to the incidence angle θ₁ and reflection efficiency, and the incidence angle when the property is changed is called a polarization angle θ₁. For example, the optical signal 10 has properties of both P polarization and S polarization, but when the optical signal 10 is incident onto glass from air according to the polarization angle θ₁, the optical signal 10 is reflected while maintaining the property of S polarization but while not maintaining the property of P polarization.

The head-up display device needs to emit an optical signal having the property of the S polarization in order to maximally reflect the optical signal emitted from the LCD in consideration of reflection efficiency due to the influence of the polarization angle.

The head-up display device may implement and emit the optical signal having the property of the S polarization by using the absorptive polaroid film of the LCD, but a polarization direction of the optical signal reflected is rotated around an optical axis due to the influence of a shape of a mirror onto which the optical signal is to be incident, and a reflective coating of the mirror, and thus the optical signal fails to be reflected and emitted in a desired polarization direction, such that the loss of the optical signal occurs, and as a result, brightness of a virtual image finally displayed by a windshield deteriorates.

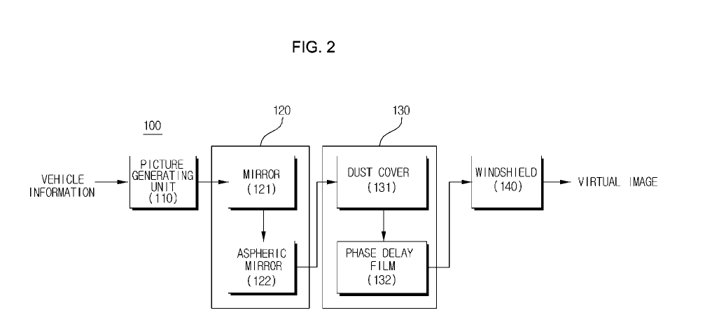

Referring to FIG. 2, a head-up display device 100 according to an embodiment of the present invention may include a picture generating unit 110, a mirror unit 120, a dust cover assembly 130, and a windshield 140.

The picture generating unit 110 is a device that generates an optical signal corresponding to an image for displaying, as a virtual image, traveling information, such as a position, a speed, and a fuel quantity of a vehicle, and a LCD or a digital light processing (DLP) scanning device may be used for the picture generating unit 110.

When the LCD is used, a polaroid film is attached to the LCD, such that an optical signal emitted from the LCD may be changed to be in a form of linear polarization (S polarization) having a predetermined polarization direction, thereby maximally reducing the signal loss of the optical signal transferred by various components.

When the DLP scanning device is used, an optical signal in a form of circular polarization may be generated, and then changed to be in a form of linear polarization by using the dust cover assembly 130, thereby maximally reducing the signal loss of the optical signal transferred by various components.

The mirror unit 120 is an optical system for generating an image by using a phenomenon such as reflection and refraction of an optical signal, and may include a mirror 121 and an aspheric mirror 122.

The mirror 121 is an optical component that receives an optical signal from the picture generating unit 110, reflects or refracts the received optical signal, and transfers the reflected or refracted optical signal to the aspheric mirror 122.

The aspheric mirror 122 is an optical component that receives the optical signal from the mirror 121, reflects or refracts the received optical signal, and transfers the reflected or refracted optical signal to the dust cover assembly 130. The aspheric mirror 122 has a shape of being flat from the center toward the outside so as to relieve a distortion phenomenon of an image corresponding to the optical signal.

The dust cover assembly 130 may include a dust cover 131 and a phase delay film 132.

The dust cover 131 is an optical component that blocks foreign substances such as dust and transmits an optical signal, and to this end, the dust cover 131 may be made of polycarbonate (PC). The dust cover 131 may transmit the optical signal transferred from the aspheric mirror 122, thereby transferring the optical signal to the windshield.

The phase delay film 132 is coated on the dust cover 131 and adjusts a polarization direction of the optical signal transmitted to transmit the optical signal in the form of horizontal polarization (S polarization). The phase delay film 132 may have a phase delay value to delay a phase for adjusting a polarization direction of the optical signal.

The phase delay film 132 may be formed in an anisotropic crystal structure by a process of tensioning, coating, and polarizing the phase delay film 132, so as to have a specific phase delay value by the anisotropic crystal structure formed in a predetermined direction.

Here, the phase delay value may be variously set by the process of tensioning, coating, and polymerizing the phase delay film 132, and the phase delay film 132 may have a phase delay value of λ/2, λ/3, λ/4, and the like based on a center wavelength (for example, λ=550 nm) in a visible light region of the optical signal.

The phase delay film 132 may be made of polymethyl methacrylate (PMMA) or polycarbonate (PC) which is the same material as the dust cover, but is not limited thereto.

The windshield 140 is installed at the front of a vehicle, and may not only perform a general role of blocking wind coming from the outside but also serve as an optical component which reflects or refracts an optical signal transferred from the dust cover assembly 130 and converts the reflected or refracted optical signal into a virtual image in front of a driver's view so as to be viewed by a driver.

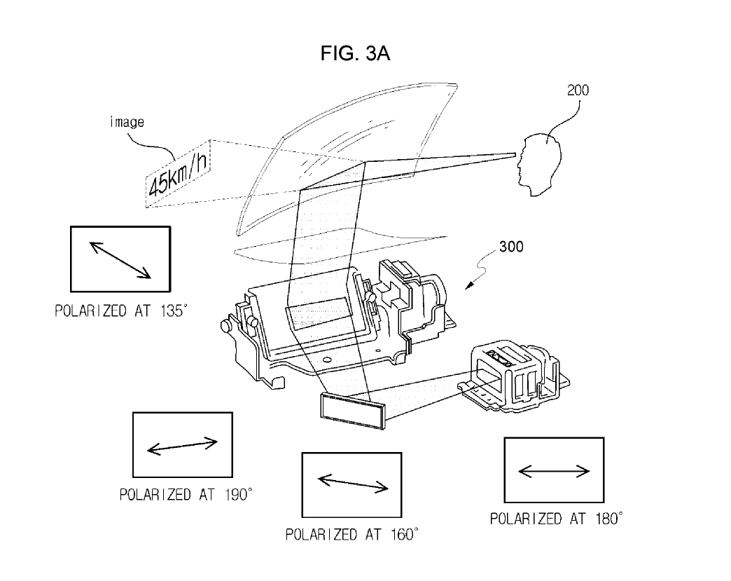

Referring to FIG. 3B, it can be confirmed that an optical signal having a changed polarization direction (angle) is converted into a virtual image in front of a view of a driver 200 by the head-up display device 100 according to the embodiment of the present invention.

FIG. 3A illustrates that when a head-up display device 300 according to the related art emits an optical signal in the form of horizontal polarization (polarized at 180°), the optical signal is changed to be sequentially polarized at 160°, 190°, and 135° by shapes and coating characteristics of various optical components (for example, a mirror), and the changed optical signals are transferred, brightness of a virtual image shown to the driver 200 deteriorates.

In other words, this shows that a polarization angle of the optical signal that is initially emitted is 180°, but the optical signal is incident onto the windshield while being polarized at 135°, which is not horizontal to the windshield, through a mirror and an unmanaged dust cover, such that brightness of a virtual image shown to a driver deteriorates due to the polarization angle.

FIG. 3B illustrates that when the picture generating unit 110 of the head-up display device 100 including the dust cover assembly 130 according to the embodiment of the present invention emits an optical signal polarized at 130°, the optical signal is changed to be polarized at 45° by the mirror 121, changed to be polarized at 140° by the aspheric mirror 122, and then finally changed to be polarized at 180°, which is horizontal to the windshield, by the dust cover assembly 130, such that brightness loss of the virtual image does not occur.

For example, a phase delay value of the phase delay film 132 is set to λ/2 to delay a phase corresponding to 45°, but is a phase delay value for a single wavelength. In a case of an optical signal with multiple wavelengths, a phase corresponding to 40° may be finally delayed.

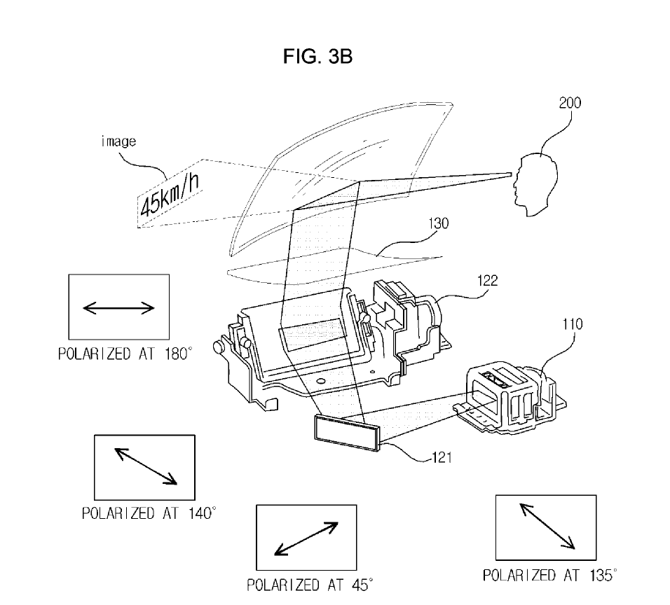

Referring to FIG. 4, a crystal structure of the phase delay film 132 may be confirmed, in which when one surface 410 of the phase delay film 132 has a crystal structure formed of oblique lines, the other surface 420 may have a crystal structure formed of oblique lines in an opposite direction to the oblique lines of the one surface 410, such that a specific phase delay value may be obtained.

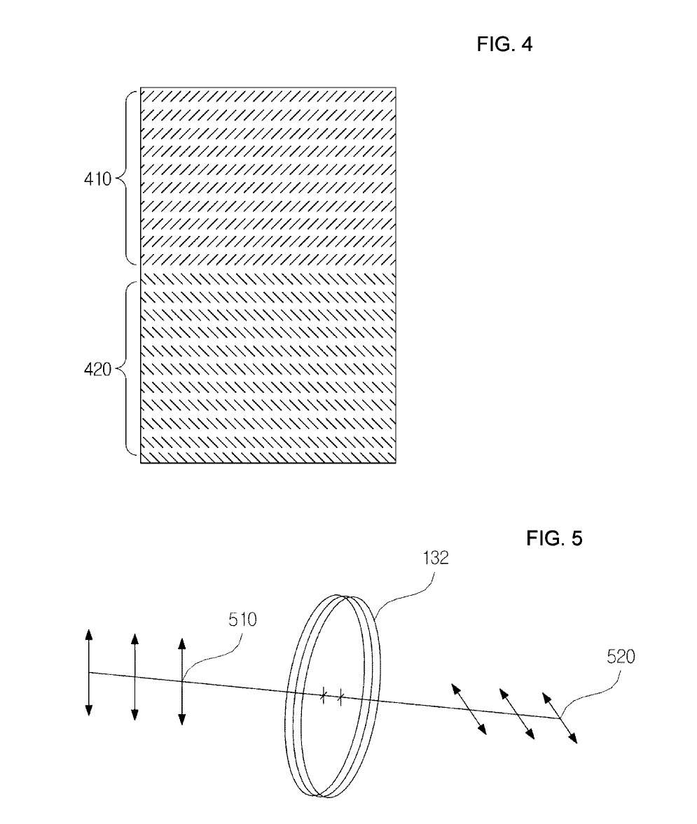

Referring to FIG. 5, it can be confirmed that when a phase delay value of the phase delay film 132 is set to λ/2, an optical signal 510 polarized at 140°, which is generated from the picture generating unit 110 using the LCD and incident onto the phase delay film 132, is rotated at 40° around an optical axis and is finally transmitted as an optical signal 520 that is horizontally polarized at 180°. This corresponds to a case where an optical signal has multiple wavelengths, and an optical signal with a single wavelength may be rotated at 45° when the phase delay value is λ2.

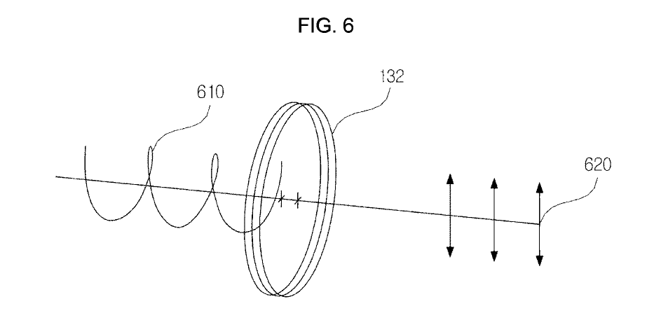

Referring to FIG. 6, it can be confirmed that when a phase delay value of the phase delay film 132 is set to λ/4, an optical signal 610 in a form of circular polarization, which is generated from the picture generating unit 110 using the DLP scanning device and incident onto the phase delay film 132, is converted into an optical signal 620 in a form of linear polarization, and the optical signal 620 is finally transmitted.

This shows that the optical signal in the form of circular polarization generated from the DLP scanning device can be changed to the optical signal in the form of horizontal polarization (S polarization) parallel to the windshield.

As described above, the embodiments have been described and illustrated in the drawings and the specification. The embodiments were chosen and described in order to explain certain principles of the invention and their practical application, to thereby enable others skilled in the art to make and utilize various embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A dust cover assembly comprising:
a dust cover configured to transmit an optical signal; and
a phase delay film overlapping the dust cover and configured to adjust a polarization direction by delaying a phase of the optical signal incident from the dust cover so as to transmit the optical signal having the adjusted polarization direction.

2. The dust cover assembly of claim 1, wherein the polarization direction of the optical signal is adjusted by an anisotropic crystal structure having a phase delay value of the phase delay film.

3. The dust cover assembly of claim 2, wherein the phase delay value is determined by tensioning, coating, and polymerizing the phase delay film.

4. The dust cover assembly of claim 3, wherein the phase delay value is set based on a center wavelength in a visible light region of the optical signal.

5. The dust cover assembly of claim 2, wherein the phase delay film is made of polycarbonate (PC) or polymethyl methacrylate (PMMA).

6. The dust cover assembly of claim 2, wherein a polarization direction of the optical signal is adjusted to be polarized at 180°.

7. The dust cover assembly of claim 1, wherein the dust cover is made of PC which blocks foreign substances such as dust and transmits the optical signal.

8. A head-up display device comprising:
the dust cover assembly according to claim 1;
a picture generating unit configured to generate an optical signal corresponding to an image;
a mirror unit configured to receive the optical signal from the picture generating unit and reflect the optical signal to the dust cover assembly; and
a windshield configured to convert the optical signal having a polarization direction adjusted by the dust cover assembly into a virtual image.

9. The head-up display device of claim 8, wherein the picture generating unit is an LCD type or a DLP scanning type.
